(19) United States
(12) Patent Application Publication
(10) Pub. No.: US 2024/0112116 A1
(43) Pub. Date: Apr. 4, 2024

(54) Systems and Methods for Automated Process Configuration and Information Storage

(71) Applicant: NetImpact Strategies, Inc., Falls Church, VA (US)

(72) Inventors: Venkatapathi R. Puvvada, Reston, VA (US); Rachel Wishner, Arlington, VA (US); Brian Rowland, Takoma Park, MD (US); Holger Brink, Chicago, IL (US); Niketa Ward, Stafford, VA (US); Qian Liu, Gaithersburg, MD (US); Clifford Kim, Gaithersburg, MD (US)

(73) Assignee: Netimpact Strategies, Inc, Falls Church, VA (US)

(21) Appl. No.: 18/375,917

(22) Filed: Oct. 2, 2023

Related U.S. Application Data
(60) Provisional application No. 63/378,032, filed on Sep. 30, 2022.
(60) Provisional application No. 63/509,631, filed on Jun. 22, 2023.

(51) Int. Cl. G06Q 10/0637; G06Q 10/0635

(52) U.S. Cl. CPC G06Q 10/06375; G06Q 10/0635

(57) ABSTRACT

Provided are methods and apparatus for automated process configuration and information storage. In an example, a computer-implemented method includes (i) accessing a database of information describing a plurality of steps, where the steps are ordered; (ii) retrieving, from the database, information describing a step in the plurality of steps; (iii) presenting, via a user interface, the information describing the step; (iv) requesting, via the user interface, a user input in response to the presented information; (v) receiving, from the user interface, information describing the user input; (vi) storing, in the database, the information describing the user input, where the storing includes affiliating the information describing user input and the information describing the step with a corresponding identifier; and (vii) identifying, based upon the user input, a next step in the plurality of steps. Other methods and apparatus are also disclosed.

### CROSS-REFERENCE TO RELATED APPLICATIONS

This United States Non-Provisional Patent application claims the benefit of U.S. Provisional Patent Application No. 63/378,032, filed Sep. 30, 2022, titled “DXOCM”, and the benefit of U.S. Provisional Patent Application No. 63/509,631, filed Jun. 22, 2023, titled “DXOCM”, the disclosures of which are hereby incorporated herein by reference in their entireties.

### FIELD OF DISCLOSURE

This disclosure relates generally to the technical fields of electronics, computer-readable media, computer engineering, and more specifically, but not exclusively, to systems and methods for automated process configuration and information storage.

### BACKGROUND

Conventional computer-implemented word processing and calendaring techniques do not sufficiently overcome problems of partially documenting human in-person meetings and resultant haphazard organizational planning. Accordingly, there are previously unaddressed and long-felt industry needs for methods and apparatus that improve upon conventional methods and apparatus.

### SUMMARY

As is described in greater detail herein, the instant disclosure describes various systems and methods for performing automated process configuration and information storage.

In some examples, provided is a system and associated method for automated process configuration and information storage, that can be used to direct and guide users in managing organizational change, human process improvement, activities necessary to successfully make changes to an organization's processes, and combinations thereof. In an embodiment, a computer-implemented method can include the following steps, stages, or operations: (i) accessing a database of information describing a plurality of steps, where the steps are ordered and comprise information describing a succession of activities configured to guide a process to assess a current state of an organizational process, assess a prospective impact of a candidate change to the organizational process, and direct user communications to implement the candidate change to the organizational process, (ii) retrieving, from the database, information describing a step in the plurality of steps, (iii) presenting, via a user interface, the information describing the step, (iv) requesting, via the user interface, a user input in response to the presented information, (v) receiving, from the user interface, information describing the user input, (vi) storing, in the database, the information describing the user input, where the storing includes affiliating the information describing user input and the information describing the step with a corresponding identifier, and (vii) identifying, based upon the user input, a next step in the plurality of steps.

In examples, (i) the requesting the user input can further include (i) presenting, to a user via the user interface, a sentiment survey about the candidate change the organizational process and (ii) the user input can include a numerical value describing the user's sentiment about the candidate change to the organizational process.

In examples, the computer-implemented method can also include (i) presenting, to a plurality of users and via a user interface device, a survey configured to identify respective levels of maturity of aspects of an organization, (ii) receiving, from the surveyed users, numerical values describing the respective levels of maturity of the aspects of the organization, (iii) calculating a maturity score for each respective aspect of the organization by averaging the respective numerical values, (iv) storing, in the database, the maturity score for each respective aspect of the organization, and (v) selecting, based upon the maturity score for each respective aspect of the organization, the step in the plurality of steps.

In some examples, the computer-implemented method can also include (i) presenting, to a plurality of users and via a user interface device, a survey configured to identify a respective level of impact due to aspects of the candidate change to the organizational process, (ii) receiving, from the surveyed users, numerical values describing the respective levels of impact due to the aspects of the candidate change to the organizational process, (iii) calculating a change impact score for each respective aspect of the candidate change to the organizational process by averaging the respective numerical values, (iv) storing, in the database, the change impact score for each respective aspect of the candidate change to the organizational process, (v) calculating an assessment score by adding the change impact score to a risk impact score, (vi) comparing the assessment score to a threshold value, and (vii) selecting, when the assessment score is lower than the threshold value, a reduced number of steps to perform in the plurality of steps relative to the number of steps performed in the plurality of steps when the assessment score meets or exceeds the threshold value.

In some examples, the computer-implemented method can also include (i) presenting, to a plurality of users and via a user interface device, a survey configured to identify a respective level of risk due to aspects of the candidate change to the organizational process, (ii) receiving, from the surveyed users, numerical values describing the respective levels of risk due to the aspects of the candidate change to the organizational process, (iii) calculating a risk score for each respective aspect of the candidate change to the organizational process by averaging the respective numerical values, (iv) storing, in the database, the risk score for each respective aspect of the candidate change to the organizational process, (v) calculating an assessment score by adding the risk impact score to a change impact score, (vi) comparing the assessment score to a threshold value, and (vii) selecting, when the assessment score is lower than the threshold value, a reduced number of steps to perform in the plurality of steps relative to the number of steps performed in the plurality of steps when the assessment score meets or exceeds the threshold value.

In some examples, the computer-implemented method can also include (i) receiving a list of users impacted by the candidate change to the organizational process, (ii) storing the list of users in the database, (iii) presenting, to users on the list of users and via a user interface device, a survey configured to identify actual respective levels of loyalty, influence, and interest in the candidate change to the organizational process by the users on the list of users, (iv) receiving, from the surveyed users, numerical values describing the actual respective levels of loyalty, influence, and interest in the candidate change, (v) retrieving, from the database, numerical values describing targeted respective levels of loyalty, influence and interest in the candidate change, (vi) calculating a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change, and (vii) storing, in the database, the stakeholder gap score.

In examples, (i) the plurality of steps can be a group of steps in a plurality of groups of steps, and (ii) each group of steps in the plurality of groups of steps can be configured to guide improving a respective type of organizational process.

In examples, provided is a system configured to automatically guide organizational change management. The system can include (i) an electronic processor configured to execute a set of computer-executable instructions and (ii) a memory communicatively coupled to the electronic processor and storing the set of computer-executable instructions. The set of computer-executable instructions can be configured to cause the electronic processor to (i) access a database of information describing a plurality of steps, wherein the steps are ordered and comprise information describing a succession of activities configured to guide a process to assess a current state of an organizational process, assess a prospective impact of a candidate change to the organizational process, and direct user communications to implement the candidate change to the organizational process, (ii) retrieve, from the database, information describing a step in the plurality of steps, (iii) present, via a user interface, the information describing the step, (iv) request, via the user interface, a user input in response to the presented information, (v) receive, from the user interface, information describing the user input, (vi) store, in the database, the information describing the user input, wherein the storing includes affiliating the information describing user input and the information describing the step with a corresponding identifier, and (vii) identify, based upon the user input, a next step in the plurality of steps.

In examples, (i) the requesting the user input can further include presenting, to a user via the user interface, a sentiment survey about the candidate change the organizational process and (ii) the user input can include a numerical value describing the user's sentiment about the candidate change to the organizational process.

In examples, the memory can further store instructions configured to cause the processor to: (i) present, to a plurality of users and via a user interface device, a survey configured to identify respective levels of maturity of aspects of an organization, (ii) receive, from the surveyed users, numerical values describing the respective levels of maturity of the aspects of the organization, (iii) calculate a maturity score for each respective aspect of the organization by averaging the respective numerical values, (iv) store, in the database, the maturity score for each respective aspect of the organization, and (v) select, based upon the maturity score for each respective aspect of the organization, the step in the plurality of steps.

In examples, the memory can further store instructions configured to cause the processor to: (i) present, to a plurality of users and via a user interface device, a survey configured to identify a respective level of impact due to aspects of the candidate change to the organizational process, (ii) receive, from the surveyed users, numerical values describing the respective levels of impact due to the aspects of the candidate change to the organizational process, (iii) calculate a change impact score for each respective aspect of the candidate change to the organizational process by averaging the respective numerical values, (iv) store, in the database, the change impact score for each respective aspect of the candidate change to the organizational process, (v) calculate an assessment score by adding the change impact score to a risk impact score, (vi) compare the assessment score to a threshold value, and (vii) select, when the assessment score is lower than the threshold value, a reduced number of steps to perform in the plurality of steps relative to the number of steps performed in the plurality of steps when the assessment score meets or exceeds the threshold value.

In examples, the memory can further store instructions configured to cause the processor to: (i) present, to a plurality of users and via a user interface device, a survey configured to identify a respective level of risk due to aspects of the candidate change to the organizational process, (ii) receive, from the surveyed users, numerical values describing the respective levels of risk due to the aspects of the candidate change to the organizational process, (iii) calculate a risk score for each respective aspect of the candidate change to the organizational process by averaging the respective numerical values, (iv) store, in the database, the risk score for each respective aspect of the candidate change to the organizational process, (v) calculate an assessment score by adding the risk impact score to a change impact score, (vi) compare the assessment score to a threshold value, and (vii) select, when the assessment score is lower than the threshold value, a reduced number of steps to perform in the plurality of steps relative to the number of steps performed in the plurality of steps when the assessment score meets or exceeds the threshold value.

In examples, the memory can further store instructions configured to cause the processor to: (i) receive a list of users impacted by the candidate change to the organizational process, (ii) store the list of users in the database, (iii) present, to users on the list of users and via a user interface device, a survey configured to identify actual respective levels of loyalty, influence, and interest in the candidate change to the organizational process by the users on the list of users, (iv) receive, from the surveyed users, numerical values describing the actual respective levels of loyalty, influence, and interest in the candidate change, (v) retrieve, from the database, numerical values describing targeted respective levels of loyalty, influence and interest in the candidate change, (vi) calculate a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change, and (vii) store, in the database, the stakeholder gap score.

In examples, (i) the plurality of steps can be a group of steps in a plurality of groups of steps and (ii) each group of steps in the plurality of groups of steps can be configured to guide improving a respective type of organizational process.

In examples, provided is a non-transitory computer-readable medium, comprising processor-executable instructions stored thereon configured to cause a processor to: (i) access a database of information describing a plurality of steps, wherein the steps are ordered and comprise information describing a succession of activities configured to guide a process to assess a current state of an organizational process, assess a prospective impact of a candidate change to the organizational process, and direct user communications to implement the candidate change to the organizational process, (ii) retrieve, from the database, information describing a step in the plurality of steps, (iii) present, via a user interface, the information describing the step, (iv) request, via the user interface, a user input in response to the presented information, (v) receive, from the user interface, information describing the user input, (vi) store, in the database, the information describing the user input, wherein the storing includes affiliating the information describing user input and the information describing the step with a corresponding identifier, and (vii) identify, based upon the user input, a next step in the plurality of steps.

In examples, (i) the requesting the user input further comprises presenting, to a user via the user interface, a sentiment survey about the candidate change the organizational process and (ii) the user input includes a numerical value describing the user's sentiment about the candidate change to the organizational process.

In examples, the non-transitory computer-readable medium can further include processor-executable instructions stored thereon configured to cause the processor to: (i) present, to a plurality of users and via a user interface device, a survey configured to identify respective levels of maturity of aspects of an organization, (ii) receive, from the surveyed users, numerical values describing the respective levels of maturity of the aspects of the organization, (iii) calculate a maturity score for each respective aspect of the organization by averaging the respective numerical values, (iv) store, in the database, the maturity score for each respective aspect of the organization, and (v) select, based upon the maturity score for each respective aspect of the organization, the step in the plurality of steps.

In examples, the non-transitory computer-readable medium can further include processor-executable instructions stored thereon configured to cause the processor to: (i) present, to a plurality of users and via a user interface device, a survey configured to identify a respective level of impact due to aspects of the candidate change to the organizational process, (ii) receive, from the surveyed users, numerical values describing the respective levels of impact due to the aspects of the candidate change to the organizational process, (iii) calculate a change impact score for each respective aspect of the candidate change to the organizational process by averaging the respective numerical values, (iv) store, in the database, the change impact score for each respective aspect of the candidate change to the organizational process, (v) calculate an assessment score by adding the change impact score to a risk impact score, (vi) compare the assessment score to a threshold value, and (vii) select, when the assessment score is lower than the threshold value, a reduced number of steps to perform in the plurality of steps relative to the number of steps performed in the plurality of steps when the assessment score meets or exceeds the threshold value.

In examples, the non-transitory computer-readable medium can further include processor-executable instructions stored thereon configured to cause the processor to: (i) present, to a plurality of users and via a user interface device, a survey configured to identify a respective level of risk due to aspects of the candidate change to the organizational process, (ii) receive, from the surveyed users, numerical values describing the respective levels of risk due to the aspects of the candidate change to the organizational process, (iii) calculate a risk score for each respective aspect of the candidate change to the organizational process by averaging the respective numerical values, (iv) store, in the database, the risk score for each respective aspect of the candidate change to the organizational process, (v) calculate an assessment score by adding the risk impact score to a change impact score, (vii) compare the assessment score to a threshold value, and (viii) select, when the assessment score is lower than the threshold value, a reduced number of steps to perform in the plurality of steps relative to the number of steps performed in the plurality of steps when the assessment score meets or exceeds the threshold value.

In examples, the non-transitory computer-readable medium can further include processor-executable instructions stored thereon configured to cause the processor to: (i) receive a list of users impacted by the candidate change to the organizational process, (ii) store the list of users in the database, (iii) present, to users on the list of users and via a user interface device, a survey configured to identify actual respective levels of loyalty, influence, and interest in the candidate change to the organizational process by the users on the list of users, (iv) receive, from the surveyed users, numerical values describing the actual respective levels of loyalty, influence, and interest in the candidate change, (v) retrieve, from the database, numerical values describing targeted respective levels of loyalty, influence and interest in the candidate change, (vi) calculate a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change, and (vii) store, in the database, the stakeholder gap score.

In examples, (i) the plurality of steps can be a group of steps in a plurality of groups of steps and (ii) each group of steps in the plurality of groups of steps can be configured to guide improving a respective type of organizational process.

Embodiments of the disclosed systems and methods are directed to processes and techniques to direct and guide users in managing organizational change, human process improvement, activities necessary to successfully make changes to an organization's processes, and combinations thereof. In some embodiments, the disclosed systems include computer architecture components that can provide interfaces, code snippets, data structures, and information relationships to enable directing and guiding users in managing organizational change, human process improvement, activities necessary to successfully make changes to an organization's processes, and combinations thereof.

In an embodiment, the disclosure is directed to a system for automatically directing and guiding users in managing organizational change, human process improvement, activities necessary to successfully make changes to an organization's processes, and combinations thereof.

The system can include a non-transitory computer-readable medium storing a set of computer-executable instructions and an electronic processor or co-processors. When executed by the processor or co-processors, the instructions cause the processor or co-processors (or a device of which they are part) to perform a set of operations that implement an embodiment of the disclosed methods.

In an embodiment, the disclosure is directed to a non-transitory computer-readable medium storing a set of computer-executable instructions, where the set of instructions can be executed by an electronic processor or co-processors to cause the processor or co-processors (or a device of which they are part) to perform a set of operations that implement an embodiment of the disclosed methods.

In some embodiments, the systems and methods disclosed herein can provide services through a SaaS or multi-tenant platform. The platform can provide access to multiple entities or tenants, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods or functions disclosed herein.

The terms “invention,” “the invention,” “this invention,” “the present invention,” “the present disclosure,” or “the disclosure” as used herein are intended to refer broadly to all the subject matter disclosed in this document, the drawings (i.e. the Figures), and to the claims. Statements containing these terms do not limit the subject matter disclosed or the meaning or scope of the claims. Embodiments covered by this disclosure are defined by the claims and not by this summary. This summary is a high-level overview of various examples and aspects of the disclosure and introduces some concepts that are further described in detail hereby. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

Other advantages of the provided systems, apparatuses, and methods will be apparent to one of ordinary skill in the art upon review of the detailed description and the included figures. While the exemplary embodiments provided hereby are susceptible to various modifications and alternative forms, specific embodiments are shown by way of example in the drawings and are described in detail herein. However, the exemplary or specific embodiments are not intended to be limited to the forms described. Rather, the disclosure covers all modifications, equivalents, and alternatives falling within the scope of the appended claims.

### BRIEF DESCRIPTION OF THE DRAWINGS

The accompanying drawings are presented to describe examples of the present teachings and are not limiting. Together with this following description, the drawings demonstrate and explain various principles of the present disclosure.

Embodiments of the disclosure are described with reference to the drawings, in which:

FIG. 1 depicts an example block diagram of an example method for automatically guiding organizational change management, in accordance with an embodiment of the disclosure.

FIG. 2A depicts an example network implementation of a system suitable for implementing examples of the disclosed subject matter.

FIG. 2B depicts an example diagram of an example computing device suitable for implementing examples of the disclosed subject matter.

FIGS. 3A and 3B are diagrams illustrating example steps for implementing automated process configuration and information storage, in accordance with an embodiment of the disclosure.

FIG. 4 is a diagram illustrating example steps for implementing automated process configuration and information storage, in accordance with an embodiment of the disclosure.

Each of the drawings is provided for illustration and description only and does not limit the present disclosure. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Provided are example methods and apparatuses that can be used to perform automated process configuration and information storage. In some examples the provided methods and apparatuses can automatically direct and guide users in activities for managing organizational change, business process improvement, or both.

One or more embodiments of the disclosed subject matter are described herein with specificity to meet statutory requirements, but this description does not limit the scope of the claims. The claimed subject matter can be embodied in other ways, can include different elements or steps, and can be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure can be practiced. The disclosure may, however, be embodied in different forms and should not be construed as limited to the embodiments set forth herein, rather, these embodiments are provided so that this disclosure will satisfy the statutory requirements and convey the scope of the disclosure to those skilled in the art.

Among others, the subject matter of the disclosure can be embodied in whole or in part as a system, as one or more methods, or as one or more devices. Embodiments can take the form of a hardware implemented embodiment, a software implemented embodiment, or an embodiment combining software and hardware aspects. For example, in some embodiments, one or more of the operations, functions, processes, or methods disclosed and/or described herein can be implemented by one or more suitable processing elements (such as a processor, co-processor, microprocessor, Central Processing Unit, Graphics Processing Unit, Tensor Processing Unit, Quantum Processing Unit, controller, or a combination thereof, as non-limiting examples) that is part of a client device, server, network element, remote platform (such as a Software as a Service (SaaS) platform), an “in the cloud” service, or other form of computing or data processing system, device, or platform.

The processing element or elements can be programmed with a set of executable instructions (e.g., software instructions), where the instructions can be stored on (or in) one or more suitable non-transitory computer-readable data storage elements, one or more suitable non-transitory computer-readable media, or both. In an embodiment, the set of instructions can be conveyed to a user through a transfer of instructions or an application that executes a set of instructions (such as over a network, e.g., the Internet). In an embodiment, a set of instructions or an application can be utilized by an end-user through access to a SaaS platform or a service provided through such a platform.

In an embodiment, the systems and methods disclosed herein can provide services through a SaaS or multi-tenant platform. The platform provides access to multiple entities, each with a separate account and associated data storage. Each account can correspond to a User, set of Users, an entity, a set or category of entities, a company, a business advisor, a set or category of Users, an industry, an organization, or a combination thereof, as examples. Each account can access one or more services, a set of which are instantiated in their account, and which implement at least a portion of one or more of the methods or functions disclosed herein.

In an embodiment, one or more of the operations, functions, processes, or methods disclosed and/or described herein can be implemented by a specialized form of hardware, such as a programmable gate array, application specific integrated circuit (ASIC), or the like. Note that an embodiment of the disclosure can be implemented in the form of an application, a sub-routine that is part of a larger application, a “plug-in,” an extension to the functionality of a data processing system or platform, or other suitable form. The following detailed description is, therefore, not to be taken in a limiting sense.

In some embodiments, the disclosed systems can advantageously improve efficiency and speed of managing organizational change and business process improvement. In some examples, the disclosed systems can advantageously direct and guide users in managing organizational change, human process improvement, activities necessary to successfully make changes to an organization's processes, and combinations thereof.

In an embodiment, the disclosed system can generate one or more blueprints, with each such blueprint being associated with process steps (i.e. a group of steps) configured to guide a user in implementing activities to manage organizational change and organizational process improvement, such as and not limited to a type of business process (e.g., product manufacturing, product distribution, providing a specific service, accounting, sales, etc.). In an embodiment, a blueprint can include one or more of a set of information types, a set of instructions, a set of controls, a set of assessment procedures, a set of model activities, or a combination thereof. In some examples, performance of a step can be automated. In some examples, and apparatuses described herein can guide a human user in performing a step. The form of a blueprint can include a set of fields, a set of labels, or a combination thereof, with each indicating a type or meaning of data associated with the field, label, or the combination thereof. The form of a blueprint can include a set of database files, reference information (e.g., a corresponding identifier), a set of database entries, or a combination thereof.

The blueprint can include information describing one or more different sets of steps for processing different information types. The blueprint can include information describing sets or types of model activities to implement steps for managing organizational change and business process improvement. In examples, the disclosed system and method can define (or construct) a set of steps for managing organizational change and business process improvement.

Further, the disclosed systems and methods can extract status and information regarding a step from a database of steps. As an example, the extracted status can be at least one of implemented or pending. The extracted information can comprise implementation details and documents generated to implement the applicable step.

In an embodiment, the disclosed systems and methods can automatically load one or more steps identified by a blueprint, mark a status of the step as implemented, copy information between steps, or a combination thereof. In an example, the disclosed systems and methods can automatically store input information, that is input at a step, in a database along with reference information identifying the input information as having been input at that step.

For example, the disclosed systems and methods can automatically guide a user by presenting the user with steps retrieved from a database storing the blueprint, where the blueprint includes a list of steps configured to guide the user in a process for managing organizational change. In some examples, the steps in the blueprint can be configured to be performed in a sequential manner, as identified by information associated with each step (e.g. a step number). In some examples, the steps in the blueprint can be configured to be performed in an ad hoc manner, where information received by a computing device at a step can be used by the computing device to determine which subsequent step is presented to the user.

In some examples, step can include a request that the user input specific information that can be used to identify a current status of an aspect of a process used by an organization, such as a degree of approval by the user of an aspect of the process used by the organization, a degree of disapproval by the user of the aspect of the process used by the organization, or a combination thereof. For example, a step can include a user survey requesting the user provide user feedback about the aspect of the process used by the organization, and receiving the user feedback about the aspect of the process used by the organization. The received user feedback can be stored in the database along with reference information (e.g. an identifier identifying an affiliation between user input and information describing a step) identifying received information as having been input at that step. Subsequently, an embodiment of the disclosed system and method can automatically use the reference information to retrieve at least a portion of the received information. In examples, the disclosed system and method can generate one or more documents including at least a portion of the received information.

As a non-limiting example, a document template can be used to generate a message to employees, where content in the message is based upon at least a portion of the received information, at least a portion of the received information is content in the message, or both.

In the context of the disclosure, a “blueprint” can be information, stored in a database, that is used to provide steps to guide organizational change management. In examples, the blueprint can be a spreadsheet. In examples, the blueprint can store information describing a step. In examples, the blueprint can include a list of steps. In examples, the blueprint can include information describing a prospective order in which steps are to be performed. The blueprints can be designed and implemented as a unique database structure that enables automation and orchestration of performing organizational change management steps, requesting user input about aspects of the current status of an organizations processes, determining which steps to present to a user at a particular time, and visualization of data outputs optionally including automated generation of documents. In examples, documents that can be automatically generated (e.g. by a device described herein) can be correspondence directed to an adopter of an organizational change. The disclosed blueprint features can be used by the data, process, and user interface layers of applications for changing use case requirements while an application is executed. In examples, at least one blueprint can be stored in a memory device as part of the application in a target environment and upgraded, updated, or both with product releases.

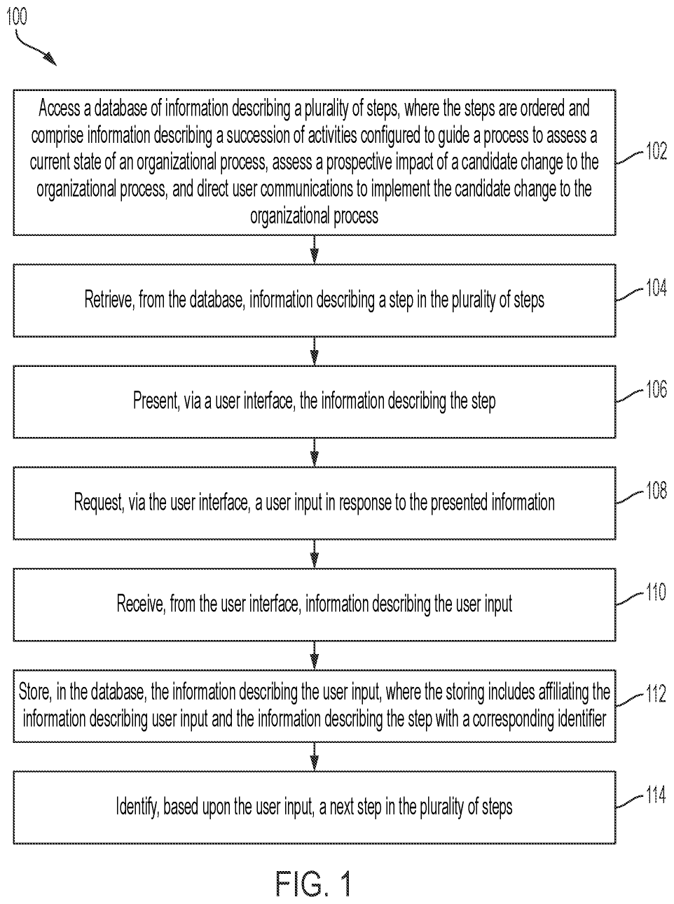

FIG. 1 depicts an example block diagram of an example method 100 that can be used to implement automated guiding of organizational change management, in accordance with an embodiment of the disclosure. In an embodiment, the method 100 can be implemented in a form of a set of computer-executable instructions. In examples, computer-executable instructions can include routines, programs, objects, components, data structures, procedures, operations, modules, or functions, as non-limiting examples. Such computer-executable instructions can be executed by one or more programmed processors or co-processors.

The order in which the method 100 is described is not intended to be construed as a limitation, and any number of the described method blocks can be combined in any order to implement the method 100 or alternate methods for automated inheritance and document generation. Additionally, individual blocks can be omitted, as is practicable, from the method 100 without departing from the scope of the subject matter described herein. Furthermore, the method 100 can be implemented in any suitable hardware, software, firmware, or a combination thereof, such as the apparatus described hereby.

As shown in FIG. 1, at step 102, one or more of the devices described herein can access a database of information describing a plurality of steps, where the steps are ordered and comprise information describing a succession of activities configured to guide a process to assess a current state of an organizational process, assess a prospective impact of a candidate change to the organizational process, and direct user communications to adopters to implement the candidate change to the organizational process.

In examples, the plurality of steps can be a group of steps (i.e. a “blueprint”) in a plurality of groups of steps (i.e. group of “blueprints”). In some embodiments, each group of steps in the plurality of groups of steps can be configured to guide improving a respective type of organizational process.

As shown in FIG. 1, at step 104, one or more of the devices described herein can retrieve, from the database, information describing a step in the plurality of steps. In some examples, one or more of the devices described herein can retrieve, from the database, a survey. The survey can include a survey question, at least one candidate survey answer (e.g. an emoji, a numerical value, a sliding scale from which a value can be chosen, the like, or a combination thereof), an explanation providing additional detail about the survey question, a prompt for a user to answer the survey question, or a combination thereof.

In some examples, one or more of the devices here described herein can retrieve, from the database, information describing text configured to be used as subject matter in an email, a letter, a text message, or a combination thereof. In some examples the information describing the text can be merged with a user's name, a user's email address, a user's postal address, a user's phone number, or a combination thereof.

As shown in FIG. 1, at step 106, one or more of the devices described herein can present, via a user interface, the information describing the step. In some examples, information describing the step can include information directing a user to perform a predetermined task. Examples of tasks are provided herein with reference to FIGS. 1, 3A, 3B, and 4.

As shown in FIG. 1, at step 108, one or more of the devices described herein can request, via the user interface, a user input in response to the presented information. Nonlimiting examples of user inputs include a user's contact information, an adopter's contact information, a stakeholder's contact information, analysis results resulting from analysis performed by a user, survey results, a user's score, information resulting from the information describing the step that is presented at step 106, text (e.g. configured to be used as subject matter in an email, a letter, a text message, or a combination thereof), the like, or a combination of.

In examples, the requesting the user input can further include presenting, to a user via the user interface, a sentiment survey about the candidate change the organizational process. In examples, the user input can include a numerical value describing the user's sentiment about the candidate change to the organizational process. The sentiment survey can include a user sentiment survey question, at least one candidate sentiment survey answer (e.g. an emoji, a numerical value, a sliding scale from which a value can be chosen, the like, or a combination thereof), an explanation providing additional detail about the sentiment survey question, a prompt for a user to answer the sentiment survey question, or a combination thereof.

As shown in FIG. 1, at step 110, one or more of the devices described herein can receive, from the user interface, information describing the user input. In examples, the information describing the user input can include at least one survey answer (e.g. information describing a user-selected emoji, information describing a numerical value, information describing a user selected value from a sliding scale, the like, or a combination thereof). In some embodiments, the information describing user input can include text (e.g. configured to be used as subject matter in an email, letter, a text message, or a combination thereof). In examples, the information describing user input can include information describing: a user's name, a user's email address, a user's postal address, a user's phone number, or a combination thereof.

As shown in FIG. 1, at step 112, one or more of the devices described herein can store, in the database, the information describing the user input, where the storing includes affiliating the information describing the user input and the information describing the step with a corresponding identifier. Using the corresponding identifier in this manner can advantageously enable efficient retrieval of the information describing the user input, the information describing the step, or both.

As shown in FIG. 1, at step 114, one or more of the devices described herein can identify, based upon the user input, a next step in the plurality of steps.

In examples, the computer-implemented method can also include performing a maturity assessment. The maturity assessment can include (i) presenting, to a plurality of users and via a user interface device, a survey configured to identify respective levels of maturity of aspects of an organization, (ii) receiving, from the surveyed users, numerical values describing the respective levels of maturity of the aspects of the organization, (iii) calculating a maturity score for each respective aspect of the organization by averaging the respective numerical values, (iv) storing, in the database, the maturity score for each respective aspect of the organization, and (v) selecting, based upon the maturity score for each respective aspect of the organization, the step in the plurality of steps.

In some examples, the computer-implemented method can also include performing a change impact assessment. The change impact assessment can include (i) presenting, to a plurality of users and via a user interface device, a survey configured to identify a respective level of impact due to aspects of the candidate change to the organizational process, (ii) receiving, from the surveyed users, numerical values describing the respective levels of impact due to the aspects of the candidate change to the organizational process, (iii) calculating a change impact score for each respective aspect of the candidate change to the organizational process by averaging the respective numerical values, (iv) storing, in the database, the change impact score for each respective aspect of the candidate change to the organizational process, (v) calculating an assessment score by adding the change impact score to a risk impact score, (vi) comparing the assessment score to a threshold value, and (vii) selecting, when the assessment score is lower than the threshold value, a reduced number of steps to perform in the plurality of steps relative to the number of steps performed in the plurality of steps when the assessment score meets or exceeds the threshold value.

In some examples, the computer-implemented method can also include performing a change risk assessment. The change risk assessment can include (i) presenting, to a plurality of users and via a user interface device, a survey configured to identify a respective level of risk due to aspects of the candidate change to the organizational process, (ii) receiving, from the surveyed users, numerical values describing the respective levels of risk due to the aspects of the candidate change to the organizational process, (iii) calculating a risk score for each respective aspect of the candidate change to the organizational process by averaging the respective numerical values, (iv) storing, in the database, the risk score for each respective aspect of the candidate change to the organizational process, (v) calculating an assessment score by adding the risk impact score to a change impact score, (vi) comparing the assessment score to a threshold value, and (vii) selecting, when the assessment score is lower than the threshold value, a reduced number of steps to perform in the plurality of steps relative to the number of steps performed in the plurality of steps when the assessment score meets or exceeds the threshold value.

In some examples, the computer-implemented method can also include performing an adopter survey. In examples, an adoptor can be classified as a resistor (i.e. a person resistant to changing organizational processes) or a champion (i.e. a person who is a proponent of changing organizational processes). The adopter survey can include (i) receiving a list of users impacted by the candidate change to the organizational process, (ii) storing the list of users in the database, (iii) presenting, to users on the list of users and via a user interface device, a survey configured to identify actual respective levels of loyalty, influence, and interest in the candidate change to the organizational process by the users on the list of users, (iv) receiving, from the surveyed users, numerical values describing the actual respective levels of loyalty, influence, and interest in the candidate change, (v) retrieving, from the database, numerical values describing targeted respective levels of loyalty, influence and interest in the candidate change, (vi) calculating a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change, and (vii) storing, in the database, the stakeholder gap score.

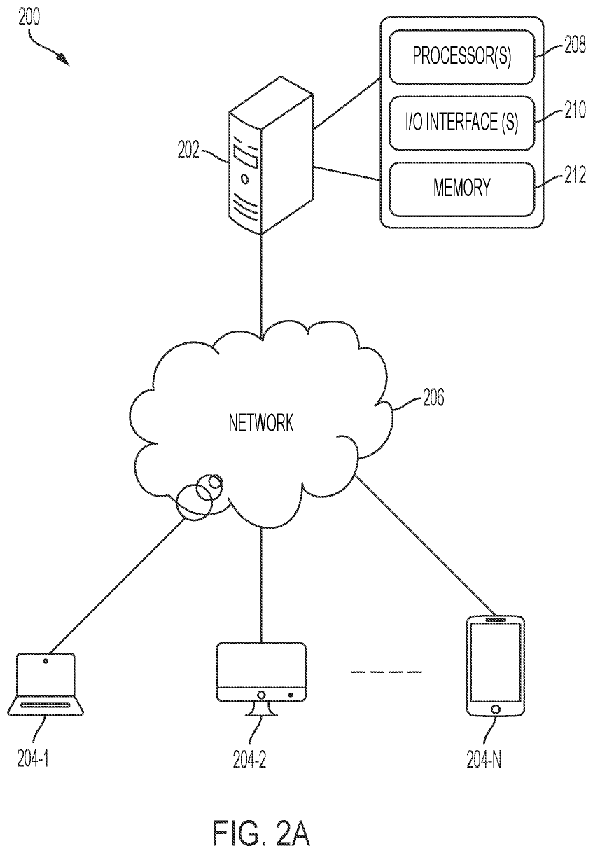

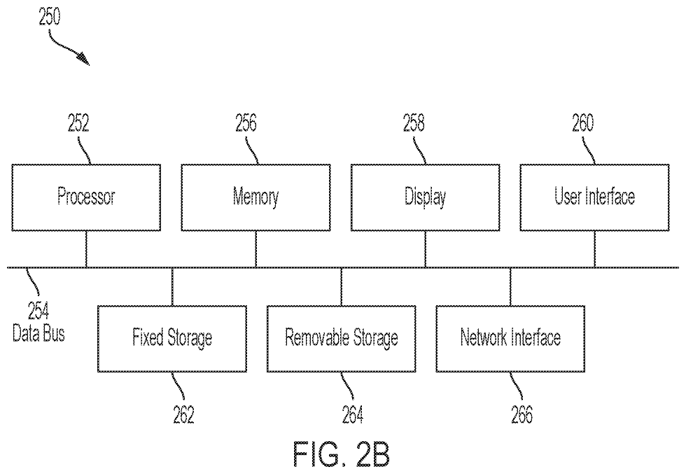

FIG. 2A depicts a network implementation 200 of a system 202 for managing organizational change management is disclosed. One or more users can access the system 202 through one or more user devices 204-1, 204-2 . . . 204-N, collectively referred to as user devices 204, hereinafter, or applications residing on the user devices 204.

Although the disclosure is explained considering that the system 202 is implemented on a server, the system 202 can be implemented in other forms of a computing device or system, such as a laptop computer, a desktop computer, a notebook, a workstation, a virtual environment, a mainframe computer, a server, a network server, or a cloud-based computing environment. It will be understood that the system 202 can be accessed by multiple users through one or more user devices 204-1, 204-2 . . . 204-N.

In one implementation, the system 202 can comprise a cloud-based computing environment in which the user can operate individual computing systems configured to execute remotely located applications. Examples of the user devices 204 can include, but are not limited to, a portable computer, a personal digital assistant, a handheld device, a workstation, or a combination thereof. The user devices 204 can be communicatively coupled to the system 202 through a network 206.

In one implementation, the network 206 can be a wireless network, a wired network, or a combination thereof. The network 206 can be implemented as one of several different types of networks, including but not limited to an intranet, local area network (LAN), wide area network (WAN), the Internet, or a combination thereof. The network 206 can be a dedicated network or a shared network. A shared network can be an association of different types of networks that use a variety of protocols, for example, Hypertext Transfer Protocol (HTTP), Transmission Control Protocol/Internet Protocol (TCP/IP), or Wireless Application Protocol (WAP) to communicate with one another. Further, the network 206 can include a variety of network devices, including routers, bridges, servers, computing devices, storage devices, or a combination thereof.

In an embodiment, system 202 can include at least one processor 208, an input/output (I/O) interface 210, and a memory 212. The processor 208 can be implemented as one or more microprocessors, microcomputers, microcontrollers, digital signal processors, Central Processing Units (CPUs), state machines, logic circuitries, devices that manipulate signals based on operational instructions, or a combination thereof. Among other capabilities, the at least one processor 208 can be configured to fetch and execute computer-readable instructions stored in the memory 212.

The in/out (I/O) interface 210 can include software and hardware interfaces, for example, a web interface, a graphical user interface, and the like. The I/O interface 210 can allow the system 202 to interact with the user directly or through the client devices 204. Further, the I/O interface 210 can enable the system 202 to communicate with other computing devices, such as web servers and external data servers (not shown). The I/O interface 210 can facilitate communications and data transfer within a wide variety of networks and protocol types, including wired networks (for example, Local Area Network or cable) and wireless networks (such as wireless local area network, a cellular network, or a satellite network). The I/O interface 210 can include one or more ports for connecting a number of devices to one another or to another server.

The memory 212 can include a computer-readable medium or computer program product. Non-limiting examples include volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, and magnetic tapes. The memory 212 can include routines, programs, objects, instructions, modules, components, or data structures which perform particular tasks or implement particular abstract data types. The memory 212 can include programs or instructions that supplement applications and functions of the system 202. In an embodiment, the memory 212 can serve as a repository for storing data processed, received, and generated by one or more of the programs or the coded instructions.

FIG. 2B depicts an example diagram of an example computing device 250 suitable for implementing examples of the disclosed subject matter. For example, at least a portion of the computing device 250 can be suitable for use as a component part of the system 202, the user devices 204, or a combination thereof. In another example, at least a portion of the computing device 250 can be coupled to the network 206.

In examples, aspects of the computing device 250 can be implemented at least in part in a desktop computer, a laptop computer, a server, a mobile device, a special-purpose computer, a non-generic computer, an electronic device described hereby (as is practicable), the like, or a combination thereof. In some examples, the disclosed subject matter can be implemented in, and used with, hardware devices, computer network devices, the like, or a combination thereof. The configuration depicted in FIG. 2B is an illustrative example and is not limiting.

In some examples, the computing device 250 can include a processor 252, a data bus 254, a memory 256, a display 258, a user interface 260, a fixed storage device 262, a removable storage device 264, a network interface 266, the like, or a combination thereof. These elements are described in further detail herein.

The processor 252 can be a hardware-implemented processing unit configured to control at least a portion of operation of the computing device 250. The processor 252 can perform logical and arithmetic operations based on processor-executable instructions stored within the memory 256. The processor 252 can be configured to execute instructions which cause the processor 252 to initiate at least a part of a method described hereby. In an example, the processor 252 can interpret instructions stored in the memory 256 to initiate at least a part of a method described hereby. In an example, the processor 252 can execute instructions stored in the memory 256 to initiate at least a part of a method described hereby. The instructions, when executed by the processor 252, can transform the processor 252 into a special-purpose processor that causes the processor to perform at least a part of a function described hereby. The processor 252 can also be referred to as a central processing unit (CPU), a special-purpose processor (e.g., a non-generic processor), or both.

In some examples, the computing device 250 can implement machine-learning techniques (e.g., using a Convolutional Neural Network (CNN), etc.) to collect information, process information, or both. In some examples, information stored in an information storage device of the computing device 250 can be transferred to another computing device 250 (or other type of computing device) and thus negate a need for another machine-learning training cycle.

The processor 252 can comprise or be a component of a physical processing system implemented with one or more processors. In some examples, the processor 252 can be implemented with at least a portion of: a microprocessor, a microcontroller, a digital signal processor (DSP) integrated circuit, a field programmable gate array (FPGA), a programmable logic device (PLD), an application-specific integrated circuit (ASIC), a controller, a state machine, a gated logic circuit, a discrete hardware component, a dedicated hardware finite state machine, a suitable physical device configured to manipulate information (e.g., calculating, logical operations, the like, or a combination thereof), the like, or a combination thereof.

The data bus 254 can couple components of the computing device 250. The data bus 254 can enable information communication between the processor 252 and one or more components coupled to the processor 252. In some examples, the data bus 254 can include a data bus, a power bus, a control signal bus, a status signal bus, the like, or a combination thereof. In an example, the components of the computing device 250 can be coupled together to communicate with each other using a different suitable mechanism.

The memory 256 generally represents any type or form of volatile storage device, non-volatile storage device, medium, the like, or a combination thereof. The memory 256 can store data (e.g. a database), processor-readable instructions, the like, or a combination thereof. In an example, the memory 256 can store data, load data, maintain data, or a combination thereof. In an example, the memory 256 can store processor-readable instructions, load processor-readable instructions, maintain processor-readable instructions, or a combination thereof. In some embodiments, the memory 256 can store computer-readable instructions configured to cause a processor (e.g., the processor 252) to initiate performing at least a portion of a method described hereby. The memory 256 can be a main memory configured to store an operating system, an application program, the like, or a combination thereof. The memory 256 can store a basic input-output system (BIOS) which can control basic hardware operation such as interaction of the processor 252 with peripheral components. The memory 256 can also include a non-transitory machine-readable medium configured to store software. Software can mean any type of instructions, whether referred to as at least one of software, firmware, middleware, microcode, hardware description language, the like, or a combination thereof. Processor-readable instructions can include code (e.g., in source code format, in binary code format, executable code format, or in any other suitable code format).

The memory 256 can include at least one of read-only memory (ROM), random access memory (RAM), a flash memory, a cache memory, an erasable programmable read-only memory (EPROM), an electrically erasable programmable read-only memory (EEPROM), a register, a hard disk drive (HDD), a solid-state drive (SSD), an optical disk drive, other memory, the like, or a combination thereof which is configured to store information (e.g., data, processor-readable instructions, software, a database, the like, or a combination thereof) and is configured to provide the information to the processor 252.

The display 258 can include a component configured to visually convey information to a user of the computing device 250. In examples, the display 258 can be a video display screen, such as a light-emitting diode (LED) screen, a touch screen, or both.

The user interface 260 can include user devices such as a switch, a keypad, a keyboard, a touch screen, a microphone, a speaker, an audio production device, a jack for coupling the computing device to an audio production device, the like, or a combination thereof. The user interface 260 can optionally include a user interface controller. The user interface 260 can include a component configured to convey information to a user of the computing device 250, a component configured to receive information from the user of the computing device 250, or both.

The fixed storage device 262 can include one or more hard drive, flash storage device, the like, or a combination thereof. The fixed storage device 262 can be an information storage device (e.g. storing a database) that is not configured to be removed during use. The fixed storage device 262 can optionally include a fixed storage device controller. The fixed storage device 262 can be integral with the computing device 250 or can be separate and accessed through an interface.

The removable storage device 264 can be integrated with the computing device 250 or can be separated and accessed through other interfaces. The removable storage device 264 can be an information storage device (e.g. storing a database) that is configured to be removed during use, such as a memory card, a jump drive, a flash storage device, an optical disk, the like, or a combination thereof. The removable storage device 264 can optionally include a removable storage device controller. The removable storage device 264 can be integrated with the computing device 250 or can be separate and accessed through an interface.

In examples, a computer-readable storage medium such as one or more of the memory 256, the fixed storage device 262, the removable storage device 264, a remote storage location, the like, or a combination thereof can store non-transitory computer-executable instructions configured to cause a processor (e.g., the processor 252) to implement at least an aspect of the present disclosure.

The network interface 266 can couple the processor 252 (e.g., via the data bus 254) to a network and enable exchanging information between the processor 252 and the network. In some examples, the network interface 266 can couple the processor 252 (e.g., via the data bus 254) to the network and enable exchanging information between the processor 252 and another computing device. For example, the network interface 266 can enable the processor 252 to communicate with one or more other network devices. The network interface 266 can couple to the network using any suitable technique and any suitable protocol. In some examples, the network interface 266 can include a data bus, a power bus, a control signal bus, a status signal bus, the like, or a combination thereof. Example techniques and protocols the network interface 266 can be configured to implement include digital cellular telephone, WiFi™, Bluetooth®, near-field communications (NFC), the like, or a combination thereof.

The network can couple the processor 252 to one or more other network devices. In some examples, the network can enable exchange of information between the processor 252 and the one or more other network devices. In some examples, the network can enable exchange of information between the processor 252 and another computing device. The network can include one or more private networks, local networks, wide-area networks, the Internet, other communication networks, the like, or a combination thereof. In some examples, the network can be a wired network, a wireless network, an optical network, the like, or a combination thereof.

In some embodiments, the network device can store computer-readable instructions configured to cause a processor (e.g., the processor 252) to initiate performing at least a portion of a method described hereby. In an example, the one or more other network devices can store non-transitory computer-executable instructions configured to cause a processor (e.g., the processor 252) to implement at least an aspect of the present disclosure. The non-transitory computer-executable instructions can be received by the processor 252 and implemented using at least a portion of techniques described hereby. In another example, information described hereby can be stored in the fixed storage device 262, the removable storage device 264, the network device, the like, or a combination thereof.

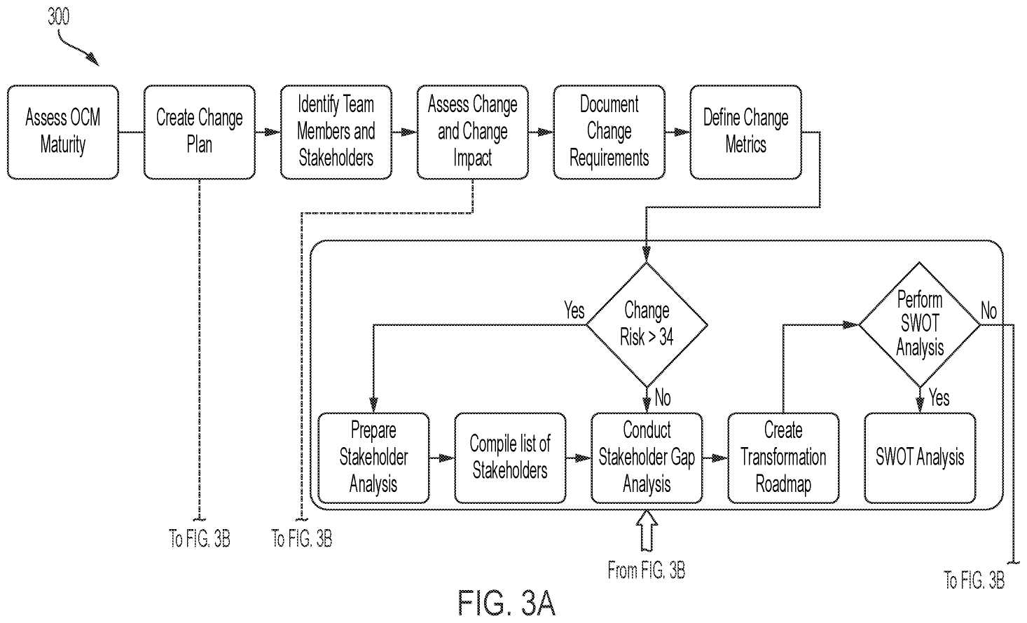

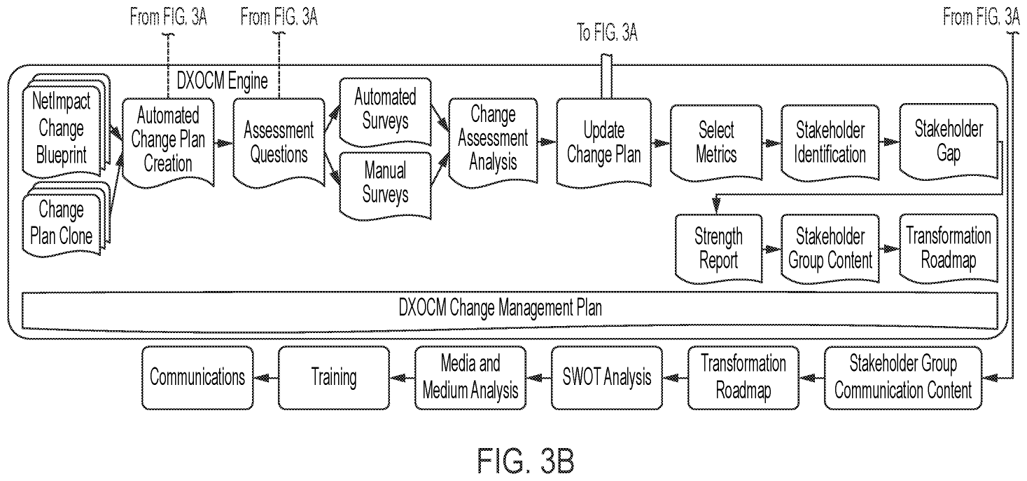

FIGS. 3A and 3B are diagrams illustrating example steps for implementing automated process configuration and information storage 300, in accordance with an embodiment of the disclosure. The example steps in FIGS. 3A and 3B are non-limiting and provide an example process for automated guiding of organizational change management (OCM). During execution of the steps, results of some steps can cause a computing system to automatically omit other steps. Further, execution of steps can result in user-provided information being stored in a database. The user-provided information can be stored in the database and associated with a step via a respective corresponding identifier. The identifier thus can be used during future information retrieval from the database to refer to the association between the user-provided information in the respective step. In examples, at least one example step in FIGS. 3A and 3B can be a constituent part of a group of steps (i.e. a blueprint).

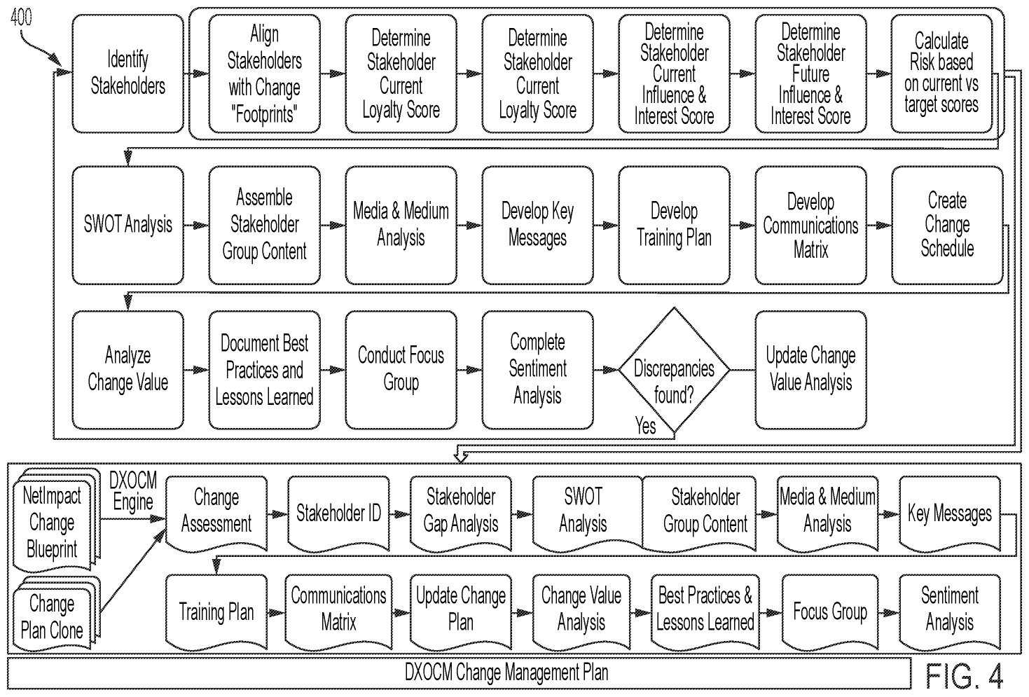

FIG. 4 is a diagram illustrating example steps for implementing automated process configuration and information storage 400, in accordance with an embodiment of the disclosure. The example steps in FIG. 4 are non-limiting and provide an example process for automated guiding of organizational change management (OCM). During execution of the steps, results of some steps can cause a computing system to automatically omit performing other steps. Further, execution of steps can result in user-provided information being stored in a database. The user-provided information can be stored in the database and associated with a step via a respective corresponding identifier. The identifier thus can be used during future information retrieval from the database to refer to the association between the user-provided information in the respective step. In examples, at least one example step in FIG. 4 can be a constituent part of a group of steps (i.e. a blueprint).

Exemplary embodiments discussed herein can provide certain advantages. These advantages can include those provided by the disclosed features.

Although systems and methods for automated management of organizational change are described hereby in a language specific to structural features and/or methods, the appended claims are not necessarily limited to the specific features or methods described. Rather, the specific features and methods are disclosed as examples of implementations for the automated management of organizational change.

It should be understood that the present invention as described herein can be implemented in a form of control logic using computer software in a modular or integrated manner. Based on the disclosure and teachings provided herein, a person of ordinary skill in the art will know and appreciate other techniques to implement an embodiment of the disclosure using hardware or a combination of hardware and software.

Any of the software components, processes or functions described in this application can be implemented as software code to be executed by a processor using any suitable computer language such as Python, Java, JavaScript, C, C++, or Perl using procedural, functional, object-oriented, or other techniques. The software code can be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium can reside on or within a single computational apparatus and can be present on or within different computational apparatuses within a system or network.

According to one example implementation, the term processing element or processor, as used herein, can be a central processing unit (CPU), or conceptualized as a CPU (such as a virtual machine). In this example implementation, the CPU or a device in which the CPU is incorporated can be coupled, connected, and/or in communication with one or more peripheral devices, such as display. In another example implementation, the processing element or processor can be incorporated into a mobile computing device, such as a smartphone or tablet computer.

The non-transitory computer-readable storage medium referred to herein can include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium can include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. In some embodiments, one or more of the blocks, or stages or steps may not necessarily need to be performed in the order presented or may not necessarily need to be performed.

The computer-executable program instructions described herein can be loaded onto a special purpose computer, a processor, or other programmable data processing apparatus to produce a specific example of a machine, such that the instructions executed by the computer, processor, or other programmable data processing apparatus create means for implementing one or more of the functions, operations, processes, or methods described herein. These computer program instructions can also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims when they have structural and/or functional elements that do not differ from the literal language of the claims, or if they include structural and/or functional elements with insubstantial differences from the literal language of the claims.

The use of the terms “a,” “an,” “the,” and similar referents in the specification and in the following claims are to be construed to cover both the singular and the plural, unless otherwise indicated herein or clearly contradicted by context. In other words, the singular portends the plural, where practicable. The terms “having,” “including,” “containing,” and similar referents in the specification and in the claims are to be construed as open-ended terms (e.g., meaning “including, but not limited to,”) unless otherwise noted. All methods described herein can be performed in any suitable order unless otherwise indicated herein or clearly contradicted by context. The use of all examples, or exemplary language (e.g., “such as”) provided herein, is intended merely to better illuminate embodiments of the disclosure and do not pose a limitation to the scope of the invention unless otherwise claimed. No language in the specification should be construed as indicating any non-claimed element as essential to each embodiment of the present invention.

The words “receiving,” “generating,” “extracting,” “determining,” “calculating,” and other forms thereof, are intended to be open ended in that an item or items following any one of these words is not meant to be an exhaustive listing of such item or items or meant to be limited to only the listed item or items. The term “or” is used inclusively to refer to items in the alternative and in combination.

Different arrangements of the components depicted in the drawings or described above, as well as components and steps not shown or described are possible. Similarly, some features and sub-combinations are useful and can be employed without reference to other features and sub-combinations. Embodiments of the invention have been described for illustrative and not restrictive purposes, and alternative embodiments will become apparent to readers of this patent. Accordingly, the present invention is not limited to the embodiments described herein or depicted in the drawings, and various embodiments and modifications can be made without departing from the scope of the claims. The disclosed embodiments are merely exemplary of the disclosure, which can be embodied in various forms.

What is claimed is:

1. A computer-implemented method for automatically guiding organizational change management, at least a portion of the method being performed by a computing device comprising at least one processor, the method comprising:
accessing a database of information describing a plurality of steps, wherein the steps are ordered and comprise information describing a succession of activities configured to guide a process to assess a current state of an organizational process, assess a prospective impact of a candidate change to the organizational process, and direct user communications to implement the candidate change to the organizational process;
retrieving, from the database, information describing a step in the plurality of steps;
presenting, via a user interface, the information describing the step;
requesting, via the user interface, a user input in response to the presented information;
receiving, from the user interface, information describing the user input;
storing, in the database, the information describing the user input, wherein the storing includes affiliating the information describing user input and the information describing the step with a corresponding identifier; and
identifying, based upon the user input, a next step in the plurality of steps.

2. The computer-implemented method of claim 1, wherein:
the requesting the user input further comprises presenting, to a user via the user interface, a sentiment survey about the candidate change the organizational process; and
the user input includes a numerical value describing the user's sentiment about the candidate change to the organizational process.

3. The computer-implemented method of claim 1, further comprising:
presenting, to a plurality of users and via a user interface device, a survey configured to identify respective levels of maturity of aspects of an organization;
receiving, from the surveyed users, numerical values describing the respective levels of maturity of the aspects of the organization;
calculating a maturity score for each respective aspect of the organization by averaging the respective numerical values;
storing, in the database, the maturity score for each respective aspect of the organization; and
selecting, based upon the maturity score for each respective aspect of the organization, the step in the plurality of steps.

4. The computer-implemented method of claim 1, further comprising:
presenting, to a plurality of users and via a user interface device, a survey configured to identify a respective level of impact due to aspects of the candidate change to the organizational process;
receiving, from the surveyed users, numerical values describing the respective levels of impact due to the aspects of the candidate change to the organizational process;
calculating a change impact score for each respective aspect of the candidate change to the organizational process by averaging the respective numerical values;
storing, in the database, the change impact score for each respective aspect of the candidate change to the organizational process;
calculating an assessment score by adding the change impact score to a risk impact score;
comparing the assessment score to a threshold value; and
selecting, when the assessment score is lower than the threshold value, a reduced number of steps to perform in the plurality of steps relative to the number of steps performed in the plurality of steps when the assessment score meets or exceeds the threshold value.

5. The computer-implemented method of claim 1, further comprising:
presenting, to a plurality of users and via a user interface device, a survey configured to identify a respective level of risk due to aspects of the candidate change to the organizational process;
receiving, from the surveyed users, numerical values describing the respective levels of risk due to the aspects of the candidate change to the organizational process;
calculating a risk score for each respective aspect of the candidate change to the organizational process by averaging the respective numerical values;
storing, in the database, the risk score for each respective aspect of the candidate change to the organizational process;
calculating an assessment score by adding the risk impact score to a change impact score;
comparing the assessment score to a threshold value; and
selecting, when the assessment score is lower than the threshold value, a reduced number of steps to perform in the plurality of steps relative to the number of steps performed in the plurality of steps when the assessment score meets or exceeds the threshold value.

6. The computer-implemented method of claim 1, further comprising:
receiving a list of users impacted by the candidate change to the organizational process;
storing the list of users in the database;
presenting, to users on the list of users and via a user interface device, a survey configured to identify actual respective levels of loyalty, influence, and interest in the candidate change to the organizational process by the users on the list of users;
receiving, from the surveyed users, numerical values describing the actual respective levels of loyalty, influence, and interest in the candidate change;
retrieving, from the database, numerical values describing targeted respective levels of loyalty, influence, and interest in the candidate change;
calculating a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change; and
storing, in the database, the stakeholder gap score.

7. The computer-implemented method of claim 1, wherein:
the plurality of steps is a group of steps in a plurality of groups of steps; and
each group of steps in the plurality of groups of steps is configured to guide improving a respective type of organizational process.

8. A system configured to automatically guide organizational change management, comprising:
an electronic processor configured to execute a set of computer-executable instructions; and
a memory communicatively coupled to the electronic processor and storing the set of computer-executable instructions, wherein the set of computer-executable instructions are configured to cause the electronic processor to:
access a database of information describing a plurality of steps, wherein the steps are ordered and comprise information describing a succession of activities configured to guide a process to assess a current state of an organizational process, assess a prospective impact of a candidate change to the organizational process, and direct user communications to implement the candidate change to the organizational process;
retrieve, from the database, information describing a step in the plurality of steps;
present, via a user interface, the information describing the step;
request, via the user interface, a user input in response to the presented information;
receive, from the user interface, information describing the user input;
store, in the database, the information describing the user input, wherein the storing includes affiliating the information describing user input and the information describing the step with a corresponding identifier; and
identify, based upon the user input, a next step in the plurality of steps.

9. The apparatus of claim 8, wherein:
the requesting the user input further comprises presenting, to a user via the user interface, a sentiment survey about the candidate change the organizational process; and
the user input includes a numerical value describing the user's sentiment about the candidate change to the organizational process.

10. The apparatus of claim 8, wherein the memory further stores instructions configured to cause the processor to:
present, to a plurality of users and via a user interface device, a survey configured to identify respective levels of maturity of aspects of an organization;
receive, from the surveyed users, numerical values describing the respective levels of maturity of the aspects of the organization;
calculate a maturity score for each respective aspect of the organization by averaging the respective numerical values;
store, in the database, the maturity score for each respective aspect of the organization; and
select, based upon the maturity score for each respective aspect of the organization, the step in the plurality of steps.

11. The apparatus of claim 8, wherein the memory further stores instructions configured to cause the processor to:
present, to a plurality of users and via a user interface device, a survey configured to identify a respective level of impact due to aspects of the candidate change to the organizational process;
receive, from the surveyed users, numerical values describing the respective levels of impact due to the aspects of the candidate change to the organizational process;
calculate a change impact score for each respective aspect of the candidate change to the organizational process by averaging the respective numerical values;
store, in the database, the change impact score for each respective aspect of the candidate change to the organizational process;
calculate an assessment score by adding the change impact score to a risk impact score;
compare the assessment score to a threshold value; and
select, when the assessment score is lower than the threshold value, a reduced number of steps to perform in the plurality of steps relative to the number of steps performed in the plurality of steps when the assessment score meets or exceeds the threshold value.

12. The apparatus of claim 8, wherein the memory further stores instructions configured to cause the processor to:
present, to a plurality of users and via a user interface device, a survey configured to identify a respective level of risk due to aspects of the candidate change to the organizational process;
receive, from the surveyed users, numerical values describing the respective levels of risk due to the aspects of the candidate change to the organizational process;
calculate a risk score for each respective aspect of the candidate change to the organizational process by averaging the respective numerical values;
store, in the database, the risk score for each respective aspect of the candidate change to the organizational process;
calculate an assessment score by adding the risk impact score to a change impact score;
compare the assessment score to a threshold value; and
select, when the assessment score is lower than the threshold value, a reduced number of steps to perform in the plurality of steps relative to the number of steps performed in the plurality of steps when the assessment score meets or exceeds the threshold value.

13. The apparatus of claim 8, wherein the memory further stores instructions configured to cause the processor to:
receive a list of users impacted by the candidate change to the organizational process;
store the list of users in the database;
present, to users on the list of users and via a user interface device, a survey configured to identify actual respective levels of loyalty, influence, and interest in the candidate change to the organizational process by the users on the list of users;
receive, from the surveyed users, numerical values describing the actual respective levels of loyalty, influence, and interest in the candidate change;
retrieve, from the database, numerical values describing targeted respective levels of loyalty, influence, and interest in the candidate change;
calculate a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change; and
store, in the database, the stakeholder gap score.

14. The apparatus of claim 8, wherein:
the plurality of steps is a group of steps in a plurality of groups of steps; and
each group of steps in the plurality of groups of steps is configured to guide improving a respective type of organizational process.

15. A non-transitory computer-readable medium, comprising processor-executable instructions stored thereon configured to cause a processor to:
access a database of information describing a plurality of steps, wherein the steps are ordered and comprise information describing a succession of activities configured to guide a process to assess a current state of an organizational process, assess a prospective impact of a candidate change to the organizational process, and direct user communications to implement the candidate change to the organizational process;
retrieve, from the database, information describing a step in the plurality of steps;
present, via a user interface, the information describing the step;
request, via the user interface, a user input in response to the presented information;
receive, from the user interface, information describing the user input;
store, in the database, the information describing the user input, wherein the storing includes affiliating the information describing user input and the information describing the step with a corresponding identifier; and
identify, based upon the user input, a next step in the plurality of steps.

16. The non-transitory computer-readable medium of claim 15, wherein:
the requesting the user input further comprises presenting, to a user via the user interface, a sentiment survey about the candidate change the organizational process; and
the user input includes a numerical value describing the user's sentiment about the candidate change to the organizational process.

17. The non-transitory computer-readable medium of claim 15, further comprising processor-executable instructions stored thereon configured to cause the processor to:
present, to a plurality of users and via a user interface device, a survey configured to identify respective levels of maturity of aspects of an organization;
receive, from the surveyed users, numerical values describing the respective levels of maturity of the aspects of the organization;
calculate a maturity score for each respective aspect of the organization by averaging the respective numerical values;
store, in the database, the maturity score for each respective aspect of the organization; and
select, based upon the maturity score for each respective aspect of the organization, the step in the plurality of steps.

18. The non-transitory computer-readable medium of claim 15, further comprising processor-executable instructions stored thereon configured to cause the processor to:
present, to a plurality of users and via a user interface device, a survey configured to identify a respective level of impact due to aspects of the candidate change to the organizational process;
receive, from the surveyed users, numerical values describing the respective levels of impact due to the aspects of the candidate change to the organizational process;
calculate a change impact score for each respective aspect of the candidate change to the organizational process by averaging the respective numerical values;
store, in the database, the change impact score for each respective aspect of the candidate change to the organizational process;
calculate an assessment score by adding the change impact score to a risk impact score;
compare the assessment score to a threshold value; and
select, when the assessment score is lower than the threshold value, a reduced number of steps to perform in the plurality of steps relative to the number of steps performed in the plurality of steps when the assessment score meets or exceeds the threshold value.

19. The non-transitory computer-readable medium of claim 15, further comprising processor-executable instructions stored thereon configured to cause the processor to:
present, to a plurality of users and via a user interface device, a survey configured to identify a respective level of risk due to aspects of the candidate change to the organizational process;
receive, from the surveyed users, numerical values describing the respective levels of risk due to the aspects of the candidate change to the organizational process;
calculate a risk score for each respective aspect of the candidate change to the organizational process by averaging the respective numerical values;
store, in the database, the risk score for each respective aspect of the candidate change to the organizational process;
calculate an assessment score by adding the risk impact score to a change impact score;
compare the assessment score to a threshold value; and
select, when the assessment score is lower than the threshold value, a reduced number of steps to perform in the plurality of steps relative to the number of steps performed in the plurality of steps when the assessment score meets or exceeds the threshold value.

20. The non-transitory computer-readable medium of claim 15, further comprising processor-executable instructions stored thereon configured to cause the processor to:
receive a list of users impacted by the candidate change to the organizational process;
store the list of users in the database;
present, to users on the list of users and via a user interface device, a survey configured to identify actual respective levels of loyalty, influence, and interest in the candidate change to the organizational process by the users on the list of users;
receive, from the surveyed users, numerical values describing the actual respective levels of loyalty, influence, and interest in the candidate change;
retrieve, from the database, numerical values describing targeted respective levels of loyalty, influence, and interest in the candidate change;
calculate a stakeholder gap score for the candidate change to the organizational process by computing a difference between the received numerical values describing the actual respective levels of loyalty, influence, and interest in the candidate change and the retrieved numerical values describing targeted respective levels of loyalty, influence, and interest in the candidate change; and
store, in the database, the stakeholder gap score.

21. The non-transitory computer-readable medium of claim 15, wherein:
the plurality of steps is a group of steps in a plurality of groups of steps; and
each group of steps in the plurality of groups of steps is configured to guide improving a respective type of organizational process.
